(19) United States
(12) Patent Application Publication
(10) Pub. No.: US 2005/0267919 A1
(43) Pub. Date: Dec. 1, 2005

(54) System for interactive processing of form documents

(75) Inventors: Brad Pivar, Vooreesville, NY (US); Jack Pivar, Delmar, NY (US); Jeffrey Frankel, Schenectady, NY (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: TRAC MEDICAL SOLUTIONS, INC.

(21) Appl. No.: 11/172,743

(22) Filed: Jun. 30, 2005

Related U.S. Application Data
(63) Continuation of application No. 09/943,670, filed on Aug. 31, 2001, now abandoned.

(51) Int. Cl. G06F 15/00

(52) U.S. Cl. 707/203

(57) ABSTRACT

A system and method for interactive processing of form documents is provided that includes the steps of selecting a form document to be processed, providing one or more requests to a first user at a first location on a computer network for information used to complete the form and receiving one or more responses from the first user used to complete the form, providing one or more requests to a second user at a second location on a computer network for information used to complete the form and receiving one or more responses from the second user used to complete the form, and writing or storing information obtained from the first and second users used to complete the form onto at least one digital file. The system may include additional features or steps of verifying whether the information submitted by the first and second users is valid for the particular form document selected and providing feedback to the first or second user based upon the information provided. A system may also be provided to secure one or more of the digital files associated with the selected form document. One method provided of securing the one or more digital files associated with the form document being processed utilizes a system and method for digital file management and authentication which facilitates automatic digital file registration and utilizes a means for inputting the digital file and a secure date and time reference providing data and time information.

### FIELD OF THE INVENTION

This invention relates generally to systems for interactive processing of form documents to be completed sequentially by multiple parties and more particularly to digital file authentication of form documents to be completed sequentially by multiple parties.

### BACKGROUND OF THE INVENTION

The use of standardized paper forms to gather, store and verify information is of widespread use in virtually every industry, government or other organization. Typically, these forms are adapted to a particular application of collecting information or completing a specific type of business transaction where the person entering the information onto the form answers a series of questions or fills in a series of blanks according to the directions indicated on the form. Often the person submitting the form is required to give his or her signature and to date the document in order to verify or attest to the information provided therein.

In many settings, form documents are designed to be completed by multiple parties and are completed in a predetermined sequential order. For example, in the medical and insurance industries, it is often necessary that forms be completed both by the party seeking reimbursement for a particular medical procedure or device, such as the insured patient or medical supplier, and by the treating physician. An example of one such document, a Certificate of Medical Necessity (CMN), is provided in FIG. 1.

The CMN shown in FIG. I has four sections to be completed. The supplier of the medical equipment typically fills out Sections A and C while the treating physician is required to complete Section B pertaining to the patient's medical condition and Section D concerning the physician's attestation and signature/date. Thus, in this example, the form is first filled out by the supplier, then sent to the physician for completion and then returned to the supplier to submit for reimbursement.

The use of form documents that must be completed by multiple parties presents a number of shortcomings. First, the form document must be completed by a first party, delivered to at least one other party and then possibly returned to the first party or another party for further processing. In the CMN example, the form document must be completed before the physician can enter his signature and date. Thus, the document is typically first completed by the supplier, further completed and signed by the physician, and then returned to the supplier in order for the supplier to seek reimbursement. The inherent delays in sending the form document through the mails or other delivery channels from a first party to the second party and then back to the first or other party greatly contributes to the length of time to process such documents.

In addition, delays in processing such form documents are further compounded by errors or a failure of one of the parties to complete the form properly or completely. In the CMN example, it is possible that the physician may have failed to complete his portion of the form completely and accurately before giving his or her signature. Because the supplier is not permitted to modify or correct the document once the document has been signed, the supplier's only option upon its discovery of the error or omission is to complete a new form to be sent to and completed by the physician resulting in wasted time and delays in processing the form document.

Second, the use of form documents to be completed sequentially by multiple parties presents an additional problem in that often one of the parties completing the document will not be familiar with the form and thus will be more prone to make errors or omissions in its completion. In addition, traditional form documents provide no way of providing feedback to the user as to the result of the information provided by the user. For example, in CMN documents, the supplier may routinely fill out these forms but the physician may not be familiar with the forms or lack the required time to ensure accurate completion. In addition, the supplier has no way to confirm whether the patient will be reimbursed based on the information provided in the form before submitting his signature. Thus, inadvertent errors or omissions in completing the form will result in undesirable delays or denial of reimbursement for the patient or supplier.

Third, because the form documents are completed sequentially by different parties there is the inherent problem that a subsequent party may alter the document without the prior party's knowledge or consent. This problem is often of greater concern in instances where one party is required to submit his signature to verify or attest to the information provided in the form and the document is sent to a subsequent party who has an interest in altering the document. Thus, there is a need to protect each party and the entity relying on the information stated in the form from tampering with the document by another party. In many instances, it is desirable to have a record of the state of the document upon each phase of completion of the document to provide audit protection for one or more of the parties submitting the form.

Thus, there is a need for a system to process form documents to be completed sequentially by multiple parties that avoids delays in processing time, reduces processing errors, provides feedback to the user during completion of the form documents, and that provides document security to detect when or how a form document has been altered.

### SUMMARY AND OBJECTS OF THE INVENTION

The foregoing and other problems and deficiencies in processing form documents to be completed by more than one party are solved and a technical advance is achieved by the present invention for interactively processing form documents over a computer network.

In various aspects it is an object of the present invention to provide a system for interactive processing of form documents to be completed sequentially by multiple parties that avoids delays in processing time; to provide a system for interactive processing of form documents that reduces processing errors; and to provide a system for interactive processing of form that provides document security to detect whether the form has been improperly or inadvertently altered by a subsequent party.

A method employed in a system for interactive processing of standardized form documents in one embodiment of the present invention comprises the steps of:

selecting a standardized form document to be completed by more than one party;

providing at least one request to a first user at a first location on a computer network for information used to complete the standardized form;

receiving at least one response to the least one request from the first user used to complete the standardized form document;

providing at least one request to a second user at a second location on the computer network for information used to complete the standardized form document;

receiving at least one response to the least one request from the second user used to complete the standardized form document; and

writing information obtained from the first and second users used to complete the standardized form document onto at least one digital file.

Alternative embodiments can include additional features or steps such as verifying whether the information submitted by either or both the first and second users completing the document is valid and complete for the particular standardized form document selected. Other embodiments can include additional features or steps so that substantive feedback is provided to the first or second users completing that standardized form document based upon the information submitted by either or both users therein.

In other embodiments, a system of processing form documents to be completed by more than one party includes a system to secure one or more digital files associated with the selected form document and information submitted by the users. In a preferred embodiment, a method of securing the one or more digital files associated with the form document being processed utilizes a system and method for digital file management and authentication which facilitates automatic digital file registration and utilizes a means for inputting the digital file and a secure date and time reference providing data and time information.

### BRIEF DESCRIPTION OF THE DRAWINGS

The foregoing and other features and advantages of the present invention will become more apparent in light of the following detailed description of exemplary embodiments thereof, as illustrated in the accompanying drawings, where

FIG. 1 illustrates an example of a specific standardized form document to be completed by more than one party.

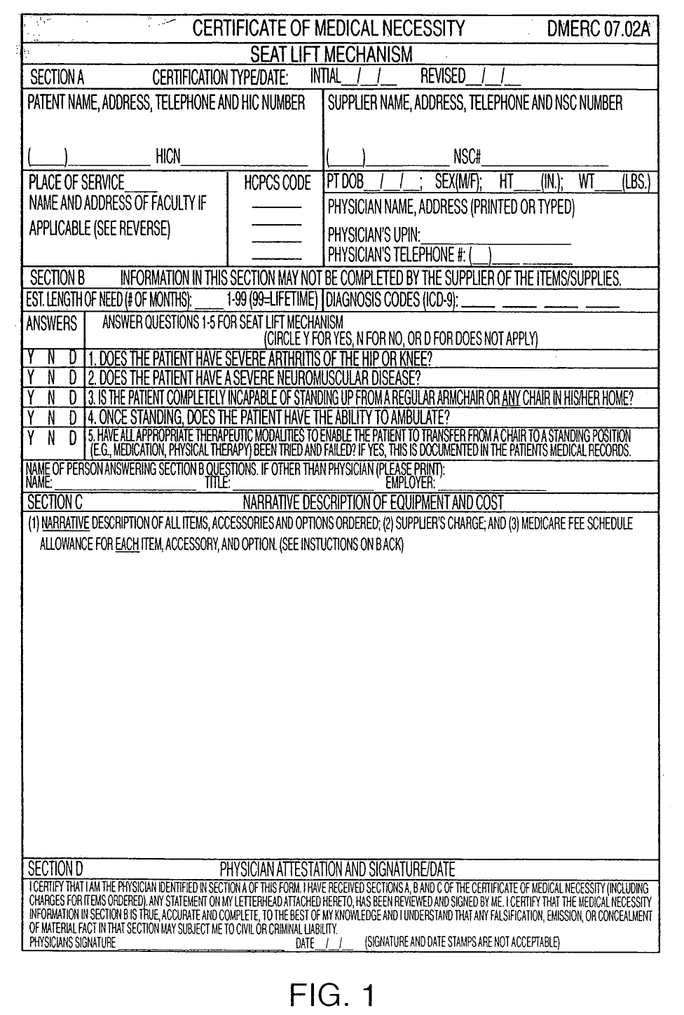

FIG. 2 illustrates a system for processing form documents over a computer network according to an embodiment of the invention.

FIG. 3 is a flow chart illustrating the steps for processing form documents to be completed by two users according to one embodiment of the present invention.

FIG. 4 is a flow chart illustrating the steps for processing a Certificate of Medical Necessity form document according to one embodiment of the present invention.

FIG. 5 illustrates a system for processing form documents over a computer network according to an embodiment of the invention.

FIG. 6 shows a flow diagram of a method of securing the one or more digital files associated with the particular form document being processed utilized in a preferred embodiment of the present invention.

FIG. 7 shows a flow diagram of a method of securing the one or more digital files associated with the particular form document being processed in which the method of securing is automatically implemented.

### DETAILED DESCRIPTION OF THE INVENTION

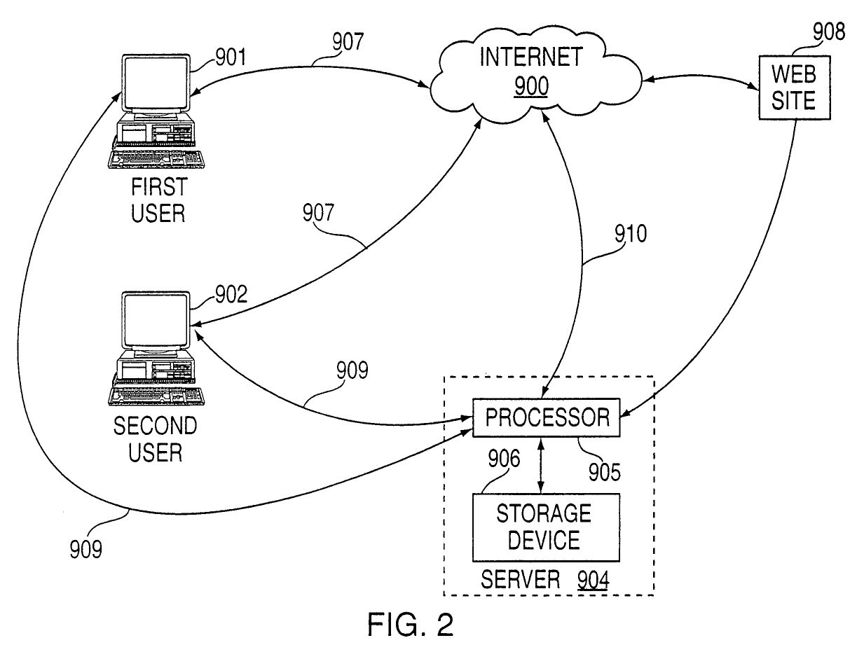

As shown in FIG. 2, a preferred embodiment of the present invention uses a computer network environment such as the Internet 900 which includes a first user 901 who provides information used to complete a standardized form, a second user 902 who provides information used to complete the standardized form, and a service provider who maintains a server 904 which may include software and hardware necessary to process a standardized form. Server 904 preferably includes processor 905 and storage device 906. Although FIG. 2 shows a computer network having two remote users and a service provider, it is possible for one of the users to maintain the processor 905 and other components necessary to process a standardized form document without the need for a third party service provider. In addition, the computer network could be a Local Area Network (“LAN”), a Wide Area Network (“WAN”), contained behind a firewall, a part of a larger computer network connected to the Internet, or combinations thereof.

According to an embodiment of the invention, the user does not maintain or need any software specific to the standardized form documents to be processed. The users only need to have access to the Internet, a direct dial-in connection with a modem, facsimile transmission capabilities, or other known means of making a connection to server 904. Exemplary methods of connecting to the server 904 are shown in FIG. 2, and include Internet connection 907 to a web site 908 maintained by the service provider; a direct dial-in connection 909 to server 904, for example, a modem connection; submission of data to the server 904 by e-mail 910; and submission to server 904 by facsimile transmission. The e-mail connection 910 is illustrated as an email system that uses the Internet 900 to transmit data. It is also possible to use an email connection that does not use the infrastructure of the Internet 900. Other connections could include wireless connections, links through dedicated computer connections, dedicated hardwire connections, or any other methods for connecting to a computer server or uploading digital documents as are known in the art. It should also be noted that although FIG. 2 shows only two users, it is possible to have more than two users and more than two locations on the network who participate in the completion or review of the standardized form document to be processed.

The system and user interface maintained on server 904 may include, as an option, a user registration and log-in procedure that requires verification of a username and password. The system checks for validity of the user information, and either allows the user access to the service or returns the user to the verification screen.

Once a first user gains access to the server 904, the user interface may provide the user with options for proceeding with the service. For example, the interface may provide a “select form document” icon which provides the user with the option of selecting a particular standardized form document from the service provider. The software and data utilized to process a particular standardized form document may be stored in storage device 906 on the provider's server 904.

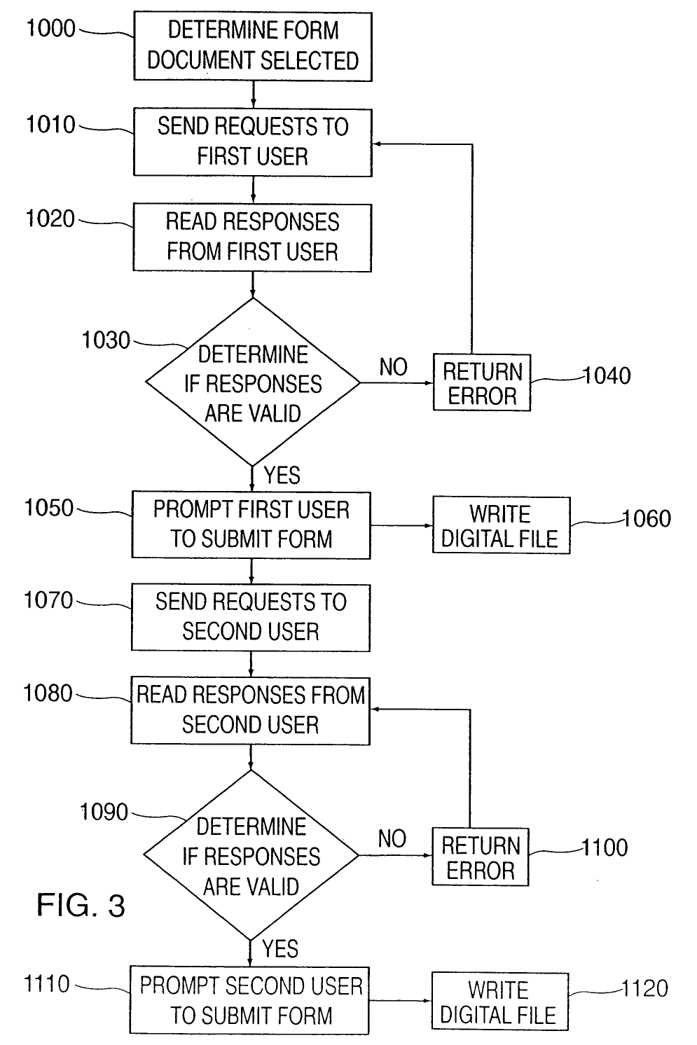

FIG. 3 shows a flow diagram of one embodiment of the present invention. The flow diagram shows exemplary steps for a method of processing form documents for which an actual implementation could include only some of, as well as additional process steps for the server 904 of FIG. 2 (or the processor 905 of other network configurations). In addition, the exemplary steps for a method of processing form documents illustrated in FIG. 3 could also be modified to allow the form document to be completed by more than two users. The method of processing form documents according to one method of the present invention involves first determining which particular form document to be processed has been selected by the first user 901 (step 1000).

Once the server 904 has determined which particular form document is to be processed, the user interface of processor 905 may provide the first user with one or more requests for information used to complete the selected standardized form document (step 1010). The substance of these requests is determined by the specifications associated with the particular standardized form document selected. For example, if the first user selects a Certificate of Medical Necessity form, the user interface of processor 905 will cause one or more requests to be sent to the first user for information such as patient name, supplier name, physician name, etc that is usually completed by a first user such as a medical supplier.

Once one or more requests have been sent to the first user 901, the first user 901 may submit responses to be read by server 904 (step 1020). Server 904 may be equipped with one or more storage devices to store the information submitted by the first user onto one or more digital files at desired intervals. It should be recognized that it is not critical how the data submitted by the first user is obtained. For example, multiple requests for information used to complete the selected standardized form documents may be transmitted to the first user at one time, or single requests for information may be sent to the first user which require a response before additional requests are sent.

According to one embodiment of the present invention, server 904 is equipped with one or more programs to verify whether the information submitted by the first user is valid for the information required for the selected standardized document. For example, the server 904 may run a routine to read the information submitted by the first user and determine, using a predetermined program associated with the selected standardized document, whether the information entered by the first user is valid for the particular standardized document (step 1030). For instance, when a Certificate of Medical Necessity form is selected, the server 904 may programmed to determine whether all applicable blanks to be completed by the supplier are filled in and that the data associated with the CMN is valid (e.g., that a valid number is entered for the physician's UPIN). If the data submitted by the first user 901 is incomplete or invalid, server 904 may send one or more additional requests to first user 901 instructing first user 901 of the error and requesting additional information (step 1040).

Once any additional information submitted by first user 901 is determined to be valid and complete, server 904 may prompt the first user to confirm that the information entered is complete (step 1050). Depending on the specific form document selected, the first user 901 may be prompted to verify or attest that the information provided by the user in the selected form document is accurate by submitting his or her signature electronically. The signature can be any data or information permitted by the selected form document that as submitted or executed, expresses an intent to sign the document.

Once the first user 901 has completed submitting information to be used to complete the selected standardized form document, server 904 may record the information submitted by first user 901 and write the information onto at least one digital file (step 1060). The digital file may also contain the specific information requested in the selected standardized form document or may contain one or more tags to indicate which unique standardized form document the data is associated with. The information submitted by first user 901 may be saved at other intervals and/or saved locally by the first user 901. In addition, although a preferred embodiment depicted in FIG. 2 utilizes a service provider in which the standardized form document is processed, verified and stored by service provider, it is possible for the first or second user 901 and 902 to download or install the necessary programs associated with the selected standardized form document and to process the standardized form document locally. In such instances, processor 905 may be maintained by either first user 901 or second user 902 to request, read and process the information associated with a particular standardized form document. In this configuration, the first user 901 and second user 902 may be connected directly without an intermediary service provider.

Once first user 901 has completed submitting information to be used to complete the selected standardized form document, server 904 may record the information submitted by first user 901 and write the information onto at least one digital file. Though it is not necessary to write the information submitted by first user 901 at this stage in the processing of the selected standardized form document, it may desirable to obtain a record of the information submitted by first user 901 before the selected standardized form document is further processed by second user 902.

In order to further process the selected standardized form document, second user 902 is prompted to complete additional information associated with the document. The second user 902 may be notified to connect to the service provider server 904 in any number of ways, including without limitation, providing a web page with the second user's unique information, sending the receipt to the user via e-mail, returning an information file over the second user's modem dial-in connection, or sending a receipt via U.S. Mail. In a preferred embodiment, first user 901 may submit contact information for second user 902 to enable server 904 to automatically send a notification to second user 902 to complete the standardized form document with instructions on how to connect to service provider server 904 (e.g., by sending an e-mail to the second user with a link to the service provider's web site).

Once second user 902 is notified to complete the standardized form document selected and partially completed by first user 901, second user 902 may connect to the server 904 by any of the exemplary methods described herein. Once second user 902 has connected to server 904, a second interactive session can begin. The user interface of processor 905 may then provide the second user with one or more requests for information used to complete the selected standardized form document (step 1070). The substance of these requests is determined according to the specification of the particular standardized form document selected by the first user. For example, if the first user selected a CMN form, the user interface of processor 905 will cause one or more requests to be sent to the second user for information that is typically completed by the physician such as information pertaining to the patient's condition. In addition, server 904 may be programmed or equipped with software associated with the selected standardized form document so that upon reading the data submitted by the first user 901, server 904 provides additional requests associated with the selected standardized form document determined according to the data entered by the first user. In the CMN example, if the supplier provided incomplete or invalid data concerning the physician's UPIN (Unique Physician Identification Number), the physician will be prompted to provide or verify such information.

Once one or more requests have been sent to the second user 902, the second user 902 may submit responses to be read by server 904 (step 1080). Server 904 may be equipped with one or more storage devices to store the information submitted by the second user onto one or more digital files at desired intervals. It should be recognized that it is not critical how the data submitted by the second user is obtained. For example, multiple requests for information used to complete the selected standardized form documents may be transmitted to the second user at one time, or single requests for information may be sent to the first user which require a response before additional requests are sent.

According to one embodiment of the present invention, server 904 is equipped with one or more programs to verify whether the information submitted by the second user is valid for the information required for the selected standardized document. For example, the server 904 may run a routine to read the information submitted by the second user and determine, using a predetermined program associated with the selected standardized document, whether the information entered by the second user is valid for the particular standardized document (step 1090). If the data submitted by the second user 902 is incomplete or invalid, server 904 may send one or more additional requests to second user 902 instructing the second user 902 of the error and requesting additional information (step 1100). Once any additional information submitted by the second user 902 is determined to be valid and complete, server 904 may prompt the second user 902 to confirm that the information entered is complete (step 1110). Depending on the specific form document selected, the second user 902 may be prompted to verify or attest that the information provided in the selected form document is accurate by submitting his or her signature electronically. The signature submitted electronically can be any data or information permitted by the selected form document that as submitted or executed, expresses an intent to sign the document.

Once second user 902 has completed submitting information to be used to complete the selected standardized form document, server 904 may record the information submitted by second user 902 and write the information onto at least one digital file (step 1120). The at least one digital file containing data from the second user 902 can be different from the at least one digital file containing information submitted by the first user 901 so long as the file contains one or more tags or other data to indicate which unique standardized form and which unique digital file containing information from the first user 901 the data submitted by the second user 902 is associated with. However, in a preferred embodiment, server 904 causes all the data submitted by both first user 901 and second user 902 to be written together onto at least one digital file. The at least one digital file may also contain the specific information requested in the selected standardized form document or one or more tags or other data to indicate which unique standardized form document the data is associated with. The information submitted by second user 902 may be saved at other intervals and/or saved locally by the first user 902.

According to one embodiment of the present invention, server 904 is equipped with one or more programs to not only verify whether the information submitted by the second user is valid for the information required for the selected standardized document but to provide substantive feedback to either or both the first user 901 and second user 902 during completion of the form. For example, server 904 may run a routine associated with the selected form document to read certain information submitted by either or both the first and second users 901 and 902 and provide substantive feedback tailored to the selected form document and based upon the information submitted by the user.

Examples of types of form documents in which it would be advantageous to provide substantive feedback to either or both of the users processing the standardized form documents are form documents utilized in the medical and insurance industries. For example, if a CMN document is being processed, it is possible according to one embodiment of the present invention to provide feedback to the physician completing the standardized form document indicating whether his or her patient will likely be entitled to reimbursement. If the patient is not entitled to reimbursement, the physician may check that the information submitted is complete and accurate before finally signing and submitting the document.

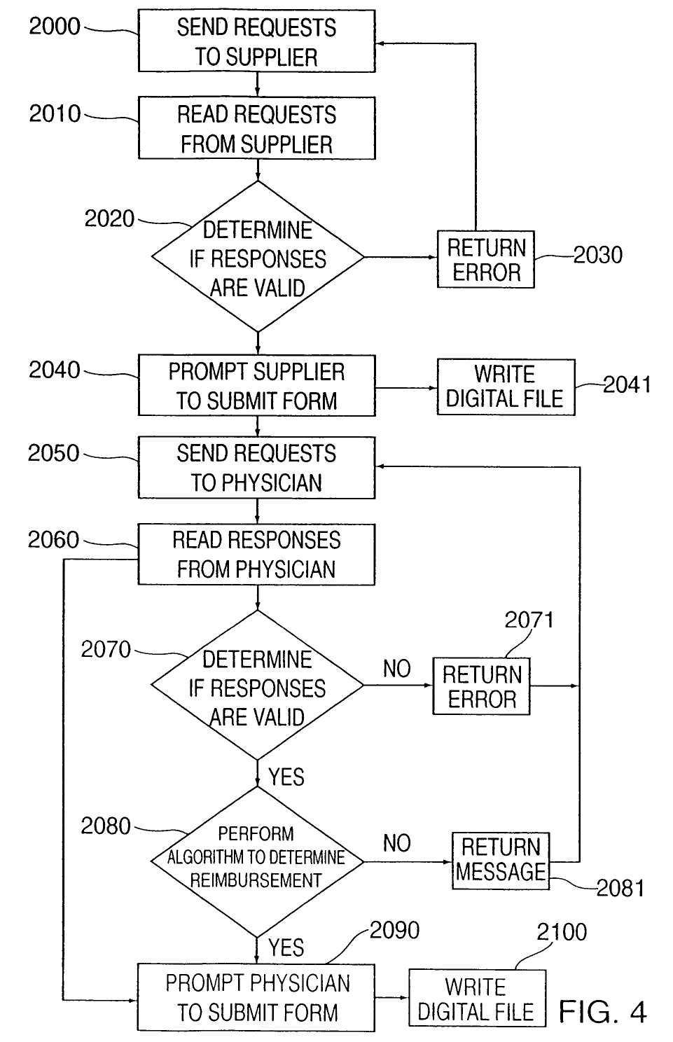

For illustrative purposes, FIG. 4 shows a flow diagram for one embodiment of the present invention in which a CMN document is selected and in which substantive feed back is provided to the physician. The flow diagram shows exemplary steps for a method of processing a CMN document for which an actual implementation could include only some of, as well as additional process steps, for the server 904 of FIG. 2 (or the processor 905 in other network configurations). In addition, the exemplary steps for a method of processing form documents illustrated in FIG. 4 could be customized for any particular form document to be completed by more than one user.

As shown in FIG. 4, the method of processing a CMN document according to one method of the present invention involves providing the supplier with one or more requests for information permitted to be completed by the supplier for the particular CMN document (step 2000), receiving one or more responses from the supplier (step 2010), verifying whether the information submitted by the supplier is valid and complete (step 2020), sending one or more additional requests for information to the supplier if the information originally submitted is incomplete or invalid (step 2030), prompting the supplier to submit the form to be further completed by the physician (step 2040) and writing or storing the information provided by the supplier onto at least one digital file (step 2041).

As further shown in FIG. 4, processing a CMN document according to one method of the present invention further involves notifying the physician to connect to the server 904 or processor 905 to complete the CMN form for a particular patient, providing the physician with one or more requests for information required to be completed by the physician for the particular CMN document (step 2050), receiving one or more responses from the physician (step 2060), verifying whether the information submitted by the physician is valid and complete (step 2070), sending one or more additional requests for information to the physician if the information originally submitted is incomplete or invalid (step 2071), performing an algorithm associated with the CMN document to determine whether information submitted by the physician and supplier is likely to result in patient reimbursement (step 2080) and sending the physician a message and/or additional requests if the patient is not entitled to reimbursement (step 2081), prompting the physician to electronically sign and submit the form to be processed (step 2090), and writing or storing the information provided by the physician onto at least one digital file (step 2100). With regard to the step of performing an algorithm to determine whether information submitted by the physician and supplier is likely to result in patient reimbursement, the algorithm may be written in any form known or developed in the art which, based upon specific data provided by the user, characteristics of the particular CMN document, and known laws or regulations concerning the requirements for reimbursement, provides a reasonable indication of whether the patient or supplier is likely to be reimbursed.

It should be recognized that the algorithm performed in Step 2080, of the CMN example shown in FIG. 4, could also be adapted to other standardized forms which based upon the data entered by one or more users and the characteristics of the selected standardized form document generate feedback to one or more aspects of particular standardized form document. For example, in the insurance industry, standardized claim forms may be interactively processed by more than one user in which the insured, hospital or physician is provided with immediate feedback as to whether patient will likely be entitled to reimbursement based by performing an algorithm based upon the data submitted, the terms and conditions of an insurance policy and other rules or regulations concerning the commercial insurance carrier.

According to one embodiment of the present invention, a method of processing form documents to be completed by more than one party includes a system to secure the one or more digital files associated with the selected form document and the information submitted by the users. The use of a system to secure the one or more digital files is particularly advantageous in cases where one or more parties completing the form document is required to submit his or her signature to verify or attest to the information provided in the form. Indeed, a user who signifies or attests that the information he or she submits in the form is truthful and accurate would like to ensure that a subsequent user of the form document does not tamper with such information. In many instances, it is desirable to have a record of the state of the document upon each phase of completion of the document to provide audit protection for one or more of the parties submitting the form document. Thus, the users completing the standardized form document and other parties relying on the accuracy of the data contained in such form documents may wish to ensure that files are not altered.

Various ways of securing a digital file are known in the art. One method is the use of Write-Once, Read-Many (“WORM”) optical media to files. One advantage of WORM media storage is that the data it houses is inherently unalterable—data can be written only one time to the medium. Another method of securing a digital file provides for registration of an “electronic signature” of a digital file. It is known to allow a user to locally select a file and locally run a program provided by a service provider to create an “electronic signature” of the selected digital file based solely on file content. The signature along with a user-provided file name and user-selected keywords are uploaded to the provider's site and stored in a registration database maintained by the service provider under an account established for the particular user. Verification of content and submittal date of the digital file at a later time requires accessing the service provider's site and retrieving the prior registration record by file name or keywords. The retrieved database record shows the file signature and the original date that the file signature was registered. To complete verification, an electronic signature routine is performed on the file to be verified and a comparison between the regenerated signature and the retrieved registered signature is made to determine whether the signature of the digital file in question matches that of the originally registered file. These and other methods known in the art of securing digital files may be utilized in accordance with one or more embodiments of the present invention.

However, one particularly advantageous method of securing the one or more digital files associated with the form document being processed utilizes a system and method for digital file management and authentication which facilitates automatic digital file registration and utilizes a means for inputting the digital file and a secure date and time reference providing data and time information. In one embodiment of a system and method for digital file management and authentication, an Authentidate™ server is utilized in which a date/time value is generated from the secure date and time information and a digital signature is generated from the digital file itself in which the digital signature and date/time value (time stamp) are stored. The following description illustrates several preferred embodiments of the present invention wherein the one or more digital files are submitted for verification by this system for digital file management and authentication. Various aspects of digital file authentication are also described in U.S. patent application Ser. No. 09/729,411 entitled “Computer Networked System and Method of Digital File Management and Authentication,” filed on Dec. 4, 2000, which is hereby incorporated by reference.

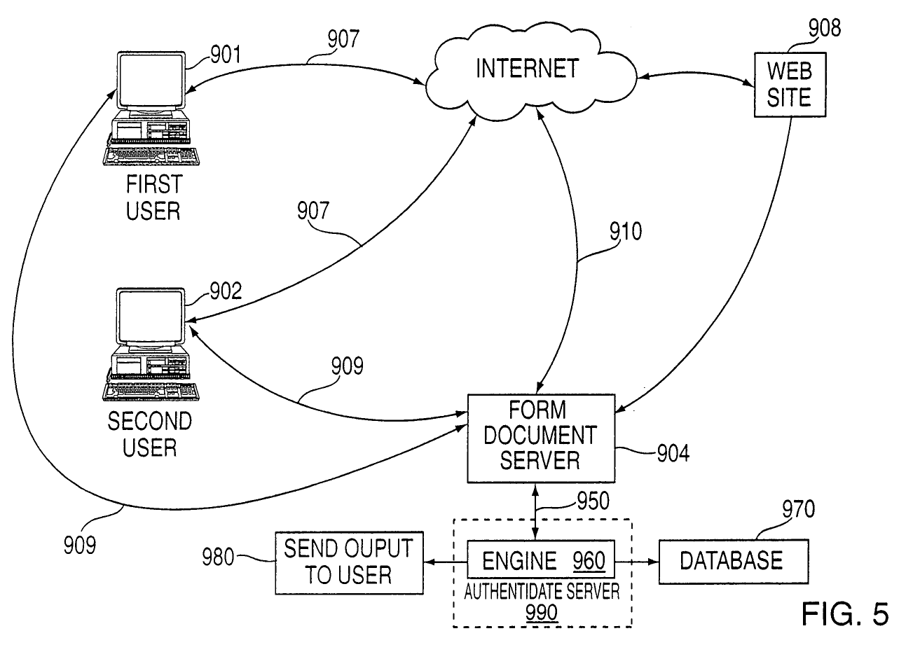

As shown in FIG. 5, a preferred embodiment of the present invention includes using a computer network environment similar to that shown in FIG. 2 wherein the server 904 of the service provider (or processor 905 in other network arrangements) further includes or else may be connected to an Authentidate server 990. An example of an Authentidate server 990 is a computer resource that provides Authentidate services such as determining a digital signature of a digital file, determining a time stamp associated with a digital file, or other processes as described herein. Authentidate server 990 may include engine 960, a port to receive a digital file 950, a port to send a digital file to a database 970 and a port to send a digital file or receipt to at least one user 980.

According to a preferred embodiment of the present invention, the one or more digital files associated with the particular form document being processed is generated by the server 904 and automatically authenticated by the additional Authentidate components of server 904 at any desired intervals during completion of the form document. However, other arrangements are possible wherein the one or more digital files associated with the particular form being processed is sent to an Authentidate server at another location or wherein the one or more digital files associated with the particular form being processed was saved locally by either the first or second users 901 or 902 and then is sent to an Authentidate server 990 at a local or remote location.

The Authentidate server 990 may maintain all of the software and hardware to perform the service, which may be referred to generally as the engine 960. The engine 960 obtains a fingerprint or digital signature of the user's file by running a digital signature program or routine on the document, such as cyclical redundancy code. Digital signature routines are known in the art and any routine may be selected for implementation into the system. A more detailed description of digital signature routines may be found in U.S. patent application Ser. No. 09/562,735 entitled “Computer Networked System and Method of Digital File Management and Authentication”, filed on May 1, 2000 which is hereby incorporated by reference. In a preferred embodiment publicly available digital signature routines such as MD-5 or SHA-1 by way of example only may be used (although more advanced publicly available digital signature routines may become available), and in the alternative embodiment a proprietary digital signature routine such as CRC-32 by way of example only may be used. After the engine 960 has obtained the digital signature of the file, the engine 960 may record the signature in a database 970.

The Authentidate server 990 may maintain a master clock in order to accurately determine the time at which the one or more digital files are delivered to the server. For example, an atomic clock which tracks Greenwich Mean Time (GMT) may be used to provide a robust and accurate time stamp for each file that is processed according to the present invention. Other clocks may be used for the purpose of recording a time stamp for each file processed, provided it is maintained for consistency and accuracy. The clock does not have to record GMT. Any time zone will suffice, so long as it is clearly specified. The time stamp may include a date, a time of day, a combination, or any other desired time criteria.

According to an embodiment of the invention, the time stamp is determined at the Authentidate server 990 as the time and date that the one or more digital files was received by the Authentidate server 990 according to a master time clock at the Authentidate server 990 that is tied, for example, to an atomic clock for accuracy.

An alternative way to record a time stamp may be to record a number that represents a quantity of units of time from a selected date. For example, in the Unix Operating system, an integer number is used to record time represented as the number of seconds measured from a specific point in time. In a similar manner, the Authentidate server 990 could record a number that represents the number of minutes, the number of seconds, or some other unit of time, from a predefined point in time. For example, the time stamp could be a number that represents the total minutes from Jan. 1, 2000 at 12:00 am. The unit of measure may be chosen depending upon the degree of accuracy desired in the time stamp. For example, if time accurate to the second is desired, then the unit should represent seconds. If more or less accuracy is needed, then the unit should be smaller or larger as desired.

The Authentidate server 990 may send a record or receipt to either or both of the first and second users 901 and 902 who submit information during processing of the form documents used to create the one or more digital files associated with the particular form document, as indicated by box 980. The record may include, for example, the filename by which the form document was submitted to the Authentidate server 990, a document identification number (ID Number) or identification tag, the time stamp, the digital signature, and a Reference field. The reference field may be specified by the user or alternatively, by the Authentidate server 990. For example, the reference field could be the title of the form document, a key phrase, or other suitable information that will be stored. The reference filed may be useful in performing a search for the document.

The ID Number may be assigned by the Authentidate server 990 as a unique identifier for every document received by the Authentidate server 990. The ID Number, for example, could be a sequential number assigned incrementally as documents are received. It may be alphanumeric if desired, and may have information encoded, such as the year or date. By way of a non-limiting example, the ID Number may be coded by date, such as 052500-500 which could indicate the 500^{th} document received on May 25, 2000. The ID Number is not required for the present system to operate but rather, is one method which may be used for identification of the one or more digital files.

Some alternative way of identifying documents rather than providing an ID number may be used. Providing a unique identification tag to document is all that is needed, whether it is an ID number, a name, or some other unique tag means, it should be unique from other identification tags. Thus, for future reference, the ID number or identification tag is sufficient to allow the Authentidate server 990 to locate information that has been stored for a document. Alternative identification tags could include, for example, that documents or files may be tagged using the filename by which the document was provided to the Authentidate server 990 (which may or may not be unique from all other files sent or uploaded) in combination with, for example, the time, date, or user associated with the uploaded document. The above elements may be re-hashed to provide additional authenticating features.

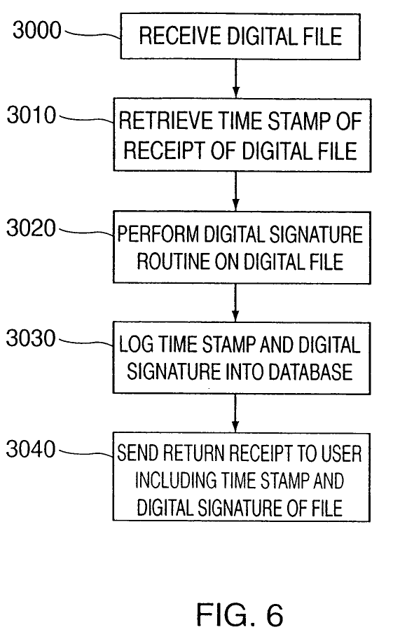

FIG. 6 shows a flow diagram of a method of securing one or more digital files associated with the particular form document being processed utilized in a preferred embodiment of the present invention. The flow diagram shows exemplary steps, for which an actual implementation could include only some of, as well as, additional process steps, for the engine 960 of FIG. 5. The Authentidate process utilized in one embodiment of the present invention includes receiving a digital file associated with a particular form document completed by a first user 901 or second user 902 (step 3000). When the file is received, the engine 960 will retrieve the time stamp to note the time of receipt of the file (step 3010). The engine 960 also performs the step of obtaining the digital signature of the document (step 3020). The information, that is, the time stamp and the digital signature, along with any other information that may be desirable, such as a document ID number, user identification information, or other document parameters, will be stored in a database maintained by the Authentidate service provider (step 3030). The engine, according to this embodiment, may also send a receipt to either the first user 901 or second user 902 which includes the pertinent information relating to the submitted digital file, including for example, the time stamp, the digital signature, the document ID number, or other information as desired (step 3040). The information could be provided to the first or second users 901 and 902 in any number of ways, including, without limitation, providing a web page with the user's unique information, sending the receipt to the user via e-mail, returning an information file over the users modem dial-in connection, or sending a receipt via U.S. Mail.

According to a preferred embodiment of the invention, Authentidate server 906 may maintain a copy of the digital file as submitted in its entirety. The file could be saved in association with the log of information to be kept on the file such as the ID number, the time stamp and the digital signature. Alternatively, the digital file itself is not save nor maintained by the Authentidate server 990. After the digital file has been processed in order to derive its digital signature, the digital file may be returned or deleted. For this alternative, a copy of the digital file is not maintained at the Authentidate site and either the first or second user 901 and 902 is responsible for maintaining a copy of the digital file associated with the standardized form document. In the future, the first or second user 901 and 902 or other third party may submit an alleged copy of the digital file associated with the particular form document that was processed, and the Authentidate server 990 can verify if the newly submitted file is the same as the digital file originally generated during processing of the form document, and further can verify the date upon which the original digital file was originally submitted to the Authentidate server.

To verify whether an alleged copy of a digital file associated with a particular form document is the same as the original digital file generated during or upon completion of the standardized form document by either the first user 901 or second user 902 on the date and time recorded in the log, the Authentidate server runs the digital signature routine on the alleged copy of the digital file to be verified. This second digital signature is compared against the original digital signature, and if they are the same, then the Authentidate server 990 will issue notice that the document is verified. If the digital signatures are not the same, then the Authenitidate sever 990 will issue notice that the document is not verified.

A user wishing to verify a file may Submit the file to Authenitidate and request verification. The verifying user may submit the file via Internet connection, direct dial modem, e-mail, or any other way discussed above or known in the art. The verifying user may provide the Authentidate server 990 with the ID number of the original file, the file name, or some other identifying method by which the Authentidate server 990 may obtain the fingerprint of the original digital file associated with a particular form document. Authentidate may then run the digital signature program on the recently submitted alleged copy of the digital file, and compare it with the digital signature or fingerprint of the originally digital file generated during completion of the particular form document. If the fingerprints compare favorably, then Authentidate will inform the verifying user that the file submitted matches the document as originally generated during processing of a particular form document on the specified date.

According to a preferred embodiment of the invention, some users may elect to have the original one or more digital files stored by the Authentidate service. The Authentidate service would then be able to supply copies to the users or third parties upon request in the future. Along with a copy of the original digital file generated during processing the standardized form document, the Authentidate service will be able to provide verification of the date upon which the original digital file was submitted. The Authentidate service may require proper security authorization before distributing copies of any documents in order to provide security and maintain privileges of the original user.

It should be recognized that the process steps may occur in any applicable order. For example, when a digital file is received, the time stamp may be determined and logged at that time, followed by running of the fingerprint routine, followed by logging of the digital file's fingerprint. Alternatively, the digital file may be received, the fingerprint may be determined, and then the time stamp and fingerprint may be logged substantially simultaneously.

As a further level of integrity and verification, the Authentidate server 990 may also perform digital signature routines on log files or database files generated by the Authentidate server 990 that contain the user information of various submitted digital files. For example, the Authentidate server 990 may create a log file or database file that contains files processed for a given period of time, such as a day or hour. For each digital file submitted and processed during the given time frame, the Authentidate server 990 records information such as the file ID, the first or second user's name, the digital signature of the file, or any other information or parameters as discussed above.

The Authentidate server 990 may then perform a digital signature routine on the log file itself, and the store the digital signature of the log file. At a later time, when a person wishes to verify a particular digital file for which a record was stored in the log file, the log file must be verified by comparing its digital signature to the digital signature of that log file at the time of storage of the information. Just as with the original digital files created during processing of the form document, if the digital signature of the log file as originally stored matches the digital signature of the log file at the time of verification, then the log file is verified and the records stored for each of the various documents written to that log file are thus verified. If the log file digital signatures to not match, then the integrity of the log file has been compromised and the data contained therein (which includes the stored digital signature of user files) cannot be relied upon. This level of integrity can be used, for example, to guard against tampering with the data.

According to a preferred embodiment of the present invention, the system is implemented so that as information concerning the particular form document being processed is saved or written onto one or more digital files, the one or more digital files are automatically sent to the Authentidate server 990 so that an authentication process can be performed on the one or more digital files without requiring the first or second users 901 and 902 to perform any additional steps to activate the process. For example, referring to FIG. 6, the system for performing the steps to authenticate a digital file are configured to activate automatically upon the execution of routine procedures not explicitly associated with the Authentidate system.

By way of example only, steps in the Authentidate process may be activated by being linked to server 904 which automatically activates the Authenitidate process upon the occurrence of an event such as each time information used to complete the particular form document being processed is received from either the first user 901 or second user 902 or at various other intervals such as upon completion of the particular form document being processed by each user.

In a preferred embodiment, the system used to secure one or more digital files associated with the form document being processed could be configured to send the digital files to a remote Authentidate server 990 where the Authentidate server 990 determines the digital signature of the document, obtains the time stamp associated with the document, sends a receipt to either or both the first user 901 and second user 902, and performs other of the steps discussed above, as desired by a user.

Authentidate services may be performed without sending the digital file to the Authentidate server to be authenticated. Such an implementation has several advantages, such as using less bandwidth. In a preferred embodiment, a system could be configured to determine a digital signature in either the server 904 (or processor 905 of either the first user 901 or second user 902 in other network configurations) and send the digital signature to a remote Authentidate server 990 where the Authentidate server 990 combines the digital signature with a secure time stamp, sends a receipt to the first or second users 901 and 902 or other third party, and performs other of the steps discussed above, as desired. In an alternative preferred embodiment, a system could be configured to determine a digital signature locally and time stamp locally, send the digital signature to a remote Authentidate server 990 where the Authentidate server 990 combines the digital signature with a secure time stamp, sends a receipt to the user and performs other of the steps discussed above, as desired by the user. Preferably, in situations where the Authentidate server does not provide a secure time stamp, the Authentidate server nonetheless performs some verification process on the time stamp, such as comparing the time stamp to the time that the digital signature and time stamp are received by the Authentidate server.

Any of the above discussed methods for securing one or more digital files associated with the form document being processed may be implemented seemlessly without requiring the first or second users 901 and 902 to invoke special procedures, follow protocols, or take additional steps beyond those typically used by the first or second users 901 and 902 during processing of the form documents. For example, upon a request to verify or submit the information provided by a first or second user 901 and 902 during completion of the form document, the user's submission of such information may automatically cause at least one digital file associated with the particular form document to be created and automatically sent to the Authentidate server for authentication without the user doing more.

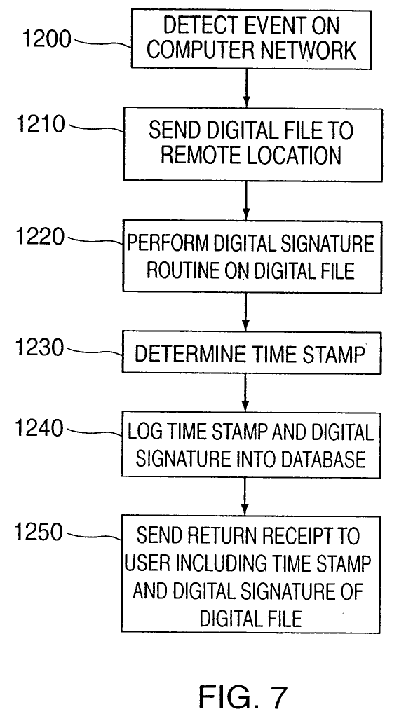

For example, with reference to FIG. 7, one embodiment of the present invention is to have the program recognize an event (step 1200), such as upon the submission of information used to complete the selected form document by first or second user 901 or 902. Once the event is detected, one or more digital files will be created and automatically authenticated by the Authentidate server. According to the implementation of FIG. 7, the system will send the one or more digital files to remote location (e.g. Authentidate server 990) for further processing (step 1210).

At the remote location, a digital signature routine (step 1220) and time stamp (step 1230) are determined and then stored in a database (step 1240). The system will then send a return receipt to the user or other third party providing the digital signature and time stamp (step 1250).

The system could be set up to perform all the services locally at the location of the first user 901 or second user 902, in order to maintain the security of sensitive documents, creating a log file of document IDs, digital signatures, or other information as desired. The system could then send the log file to a remote location to be processed and stored at a remote location. At the remote location, the log file is combined with a secure time stamp. This insures the integrity of the log file and allows for the security provided by having files remain local to the user site. For this configuration, the one or more digital files associated with the particular form being processed would be saved or stored locally by the first or second users 901 and 902.

The system could also be used as a document storage and archiving system. A user could send digital files to the Authentidate remote location, or another remote storage location, for storage of files. The digital files may have a digital signature routine performed upon them, along with the association of a time stamp corresponding to submission of the digital file or document. The Authentidate service specified by a user may include storage of the original digital files for archival purposes, such that, at a later time, the user may submit a request for the document. The Authentidate service then may provide a copy of the digital file to the user, along with other information such as a verification that it is a true and accurate copy of the original file, the date upon which original file was submitted for archiving, or other information concerning the file.

The present invention has been illustrated and described with respect to specific embodiments thereof. It is understood, however, that the above-described embodiments are merely illustrative of the principles of the invention and are not intended to be exclusive embodiments.

Alternative embodiments capturing variations in the enumerated embodiments disclosed herein can be implemented to achieve the benefits of the present invention.

It should further be understood that the foregoing and many various modifications, omissions and additions may be devised by one skilled in the art without departing from the spirit and scope of the invention.

It is therefore intended that the present invention is not limited to the disclosed embodiments but should be defined in accordance with the claims which follow.

1. A method of interactive processing of a document to be completed by more than one party over a computer network comprising:
selecting a document to be completed interactively by more than one party;
providing at least one electronic request to a first user at a first location on a computer network for information used to complete the document;
receiving at least one response to the least one electronic request from the first user to complete the document;
providing at least one electronic request to a second user at a second location on the computer network for information used to complete the document;
receiving at least one response to the least one electronic request from the second user used to complete the document; and
writing information obtained from the first and second users used to complete the document onto at least one digital file.

2. The method according to claim 1 wherein the computer network is the Internet.

3. The method according to claim 1 further comprising:
determining whether the at least one response to the least one request from the first user is valid and sending at least one additional request to the first user for additional information if the at least on response from the first user is invalid.

4. The method according to claim 3 further comprising:
determining whether the at least one response to the least one request from the second user is valid and sending at least one additional request to the second user for additional information if the at least one response from the second user is invalid.

5. The method according to claim 1 further comprising:
performing a routine determined from the selected document to provide feedback to the first user, the feedback determined in part by the at least one response to the at least one request received from the first user.

6. The method according to claim 1 further comprising:
performing a routine determined from the selected document to provide feedback to the second user, the feedback determined in part by the at least one response to the at least one request received from the second user.

7. The method according to claim 5 further comprising:
performing a routine determined from the selected document to provide feedback to the second user, the feedback determined in part by the at least one response to the at least one request received from the second user.

8. A method of interactive processing of a document to be completed by more than one party over a computer network comprising:
selecting a document to be completed by more than one party;
providing at least one request to a first user at a first location on a computer network for information used to complete the document;
receiving at least one response to the least one request from the first user used to complete the document;
providing at least one request to a second user at a second location on the computer network for information used to complete the document;
receiving at least on response to the least one request from the second user to complete the document; and
writing information obtained from the at least one response from the first and second users onto at least one digital file;
wherein upon the recognition of an occurrence of an event on the computer network, a digital file management process is performed on the at least one digital file to obtain a digital signature of the at least one digital file and wherein a time stamp corresponding to the time of the recognition of the occurrence of the event is created, the digital signature and the time stamp being sent to a remote location to allow for later authentication.

9. (Canceled)

10. A system for interactive processing of a document comprising:
a storage device;
a processor connected to the storage device and to a first and second user on a computer network;
the storage device storing a program for controlling the processor; and the processor operative with the program to:
send at least one electronic request associated with a selected document to a first user at a first location on a computer network;
receive at least one response to the at least one electronic request from the first user;
send at least one electronic request associated with the selected document to a second user at a second location on a computer network;
receive at least one response to the at least one electronic request from the second user; and
write information obtained from the at least one response from the first and second users the at least one digital file.

11. (Canceled) least one digital file in a database;

12. The method according to claim 8 wherein the computer network is the Internet.

13. The method according to claim 8 further comprising the step of:
determining whether the at least one response to the least one request from the first user is valid and sending at least one additional request to the first user for additional information if the at least on response from the first user is invalid.

14. The method according to claim 13 further comprising the step of:
determining whether the at least one response to the least one request from the second user is valid and sending at least one additional request to the second user for additional information if the at least one response from the second user is invalid.

15. The method according to claim 8 further comprising the step of:
performing a routine determined from the selected document to provide feedback to the first user, the feedback determined in part by the at least one response to the at least one request received from the first user.

16. The method according to claim 8 further comprising the step of:
performing a routine determined from the selected document to provide feedback to the second user, the feedback determined in part by the at least one response to the at least one request received from the second user.

17. The method according to claim 15 further comprising the step of:
performing a routine determined from the selected document to provide feedback to the second user, the feedback determined in part by the at least one response to the at least one request received from the second user.

18. The system according to claim 10 further comprising the step of:
determining whether the at least one response to the least one request from the first user is valid and sending at least one additional request to the first user for additional information if the at least on response from the first user is invalid.

19. The method according to claim 18 further comprising the step of:
determining whether the at least one response to the least one request from the second user is valid and sending at least one additional request to the second user for additional information if the at least one response from the second user is invalid.

20. The method according to claim 10 further comprising the step of:
performing a routine determined from the selected document to provide feedback to the first user, the feedback determined in part by the at least one response to the at least one request received from the first user.

21. The method according to claim 10 further comprising the step of:
performing a routine determined from the selected document to provide feedback to the second user, the feedback determined in part by the at least one response to the at least one request received from the second user.

22. The method according to claim 20 further comprising the step of:
performing a routine determined from the selected document to provide feedback to the second user, the feedback determined in part by the at least one response to the at least one request received from the second user.
